(19) United States
(12) Patent Application Publication
(10) Pub. No.: US 2023/0376572 A1
(43) Pub. Date: Nov. 23, 2023

(54) System and Method for Providing Temporally Adaptive Non-Fungible Tokens

(71) Applicant: Disney Enterprises, Inc., Burbank, CA (US)

(72) Inventors: Benjamin Lopez Barba, Burbank, CA (US); Alif Khalfan, Redwood City, CA (US); Malcolm E. Murdock, Los Angeles, CA (US); Zachary Shalett, Los Angeles, CA (US); Brianna Cochran, Los Angeles, CA (US)

(21) Appl. No.: 18/143,544

(22) Filed: May 4, 2023

Related U.S. Application Data
(63) Continuation of application No. 63/343,465, filed on May 18, 2022.

(51) Int. Cl. G06F 21/10

(52) U.S. Cl. CPC G06F 21/10; G06F 2221/0711

(57) ABSTRACT

A system includes a hardware processor and a memory storing software code. The hardware processor executes the software code to receive a request from a user to link a non-fungible token (NFT) with a user account of the user, verify, in response to receiving the request, ownership of the NFT by the user, and link, in response to verifying, the NFT to the user account. The hardware processor is further configured to execute the software code to modify, based on at least one of the content viewing history of the user or a release date of a content available to the user, one or more attributes of the NFT.

### RELATED APPLICATIONS

The present application claims the benefit of and priority to a pending Provisional Patent Application Ser. No. 63/343,465 filed on May 18, 2022, and titled “Temporally Adaptive NFTs,” which is hereby incorporated fully by reference into the present application.

### BACKGROUND

Although existing non-fungible token (NFT) minting and distribution schemes advantageously enable NFT collectors to buy, sell, or trade NFTs at will, those conventional NFTs are typically static artifacts that remain frozen in time and do not change. In part, that changelessness is what gives those conventional NFTs value as collectables. However, some NFT owners who interactively engage with content or activities related to the NFTs they own may wish to have those NFTs evolve to reflect those interactions or activities. Thus, there is a need in the art for NFTs capable of being modified temporally to reflect the media consumption and participatory actions of the owners of those NFTs.

### BRIEF DESCRIPTION OF THE DRAWINGS

FIG. 1 shows a system for temporally adapting non-fungible tokens (NFTs), according to one implementation;

FIG. 2 shows an exemplary system for use in temporally adapting NFTs, according to another implementation; and

FIG. 3 shows a flowchart presenting an exemplary method for temporally adapting NFTs, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The technology known as a non-fungible token (NFT) allows individual artists and companies to sell ownership rights to a digital asset, such as a file containing a photo or other image, video, audio, or any other desirable digital representation of a real or virtual object. An NFT is a unit of data stored on a secure digital ledger, such as a blockchain for example, that certifies a digital asset to be unique and therefore non-fungible. An NFT can be used to represent a digital asset which is typically stored in and accessible via the cloud, and confer ownership of that digital asset to an individual or entity. However, in contrast to traditional ownership rights, ownership of an NFT does not prevent others from accessing, or even copying, the digital asset associated with the NFT.

As noted above, although existing NFT minting and distribution schemes advantageously enable NFT collectors to buy, sell, or trade NFTs at will, those conventional NFTs are typically static artifacts that remain frozen in time and do not change, and in part, that changelessness is what gives those conventional NFTs value as collectables. However, some NFT owners who interactively engage with content or activities related to the NFTs they own may wish to have those NFTs evolve to reflect those interactions or activities.

The present solution for temporally adapting NFTs advantageously enables NFTs to be more dynamic by allowing them to be modified by updates linked to events associated with those NFTs and thus reflect newer content and more recent events. Thus temporally adaptive NFTs may not only be collectables, but may also serve as progress trackers. The present application discloses systems and methods for enabling an NFT to temporally adapt to any of a number of different actions or events, such as release or distribution of content featuring a character associated with the NFT, consumption of such content by an owner of the NFT, or the attendance of that NFT owner at an event or location associated with the NFT, to name merely a few examples. Consequently, the solution for enabling temporally adaptability of NFTs disclosed by the present application can advantageously provide NFTs that evolve while remaining relevant to the interests and activities of their respective owners.

It is noted that in some implementations, the systems and methods disclosed by the present application may be substantially or fully automated. Moreover, the present temporally adaptive NFT solution provides a web3 framework for combining streaming content with NFTs. By linking the two, i.e., streaming platforms and NFTs, the present solution for temporally adapting NFTs enables such adaptations or updates to be made automatically and require no manual handling. It is further noted that, as used in the present application, the terms “automation,” “automated,” and “automating” refer to systems and processes that do not require the participation of a human administrator. Thus, the methods described in the present application may be performed under the control of hardware processing components of the disclosed automated systems. That is to say, the present temporally adaptive NFT solution provides a web3 framework for combining streaming content with NFTs. By linking the two, streaming platforms and NFTs, updates to the NFT can be made automatically and require no manual handling.

It is also noted that, as defined in the present application, the term “NFT asset” may refer to any digital asset having its ownership certified by an NFT. Examples of an NFT asset may include a digital file containing an image or images, video without audio, audio without video, or audio-video (AV) content, such as all or part of a television (TV) episode, movie, or video game, to name a few. In addition, or alternatively, in some implementations, an NFT asset may be or include a digital representation of persons, fictional characters, locations, objects, and identifiers such as brands and logos, for example, which populate a virtual reality (VR), augmented reality (AR), or mixed reality (MR) environment. Such digital representations may depict virtual worlds that can be experienced by any number of users synchronously and persistently, while providing continuity of data such as personal identity, user history, entitlements, possessions, payments, and the like. Moreover, in some implementations, an NFT asset may be a hybrid of traditional audio-video and fully immersive VR/AR/MR experiences, such as interactive video.

The term “NFT wallet” may refer to any secure software application assigned to an owner of an NFT asset that stores the NFT credentials (e.g., public and private keys, certifying ownership of the NFT asset), and enables the NFT asset owner to reassign, i.e., sell or otherwise transfer ownership of the NFT asset to another person or entity. It is also noted that the relationship between an NFT asset and an NFT wallet is many-to-one rather than one-to-one. That is to say, in some implementations, the same NFT wallet may store NFT credentials for each of multiple NFT assets. However, the NFT credentials of an NFT asset are uniquely present in only one NFT wallet at a time.

Moreover, as defined in the present application, the terms “revoke,” “revoked,” or “revoking,” and “burn,” “burned,” or “burning,” when applied to an NFT, refer to the permanent removal of that NFT from circulation. Thus, burning or revoking of an NFT may refer to destruction of an existing NFT, or to the persistent sequestering of the NFT in a digital wallet that is inaccessible for use to purchase, trade, award, or otherwise confer possession or ownership of any NFT stored within it.

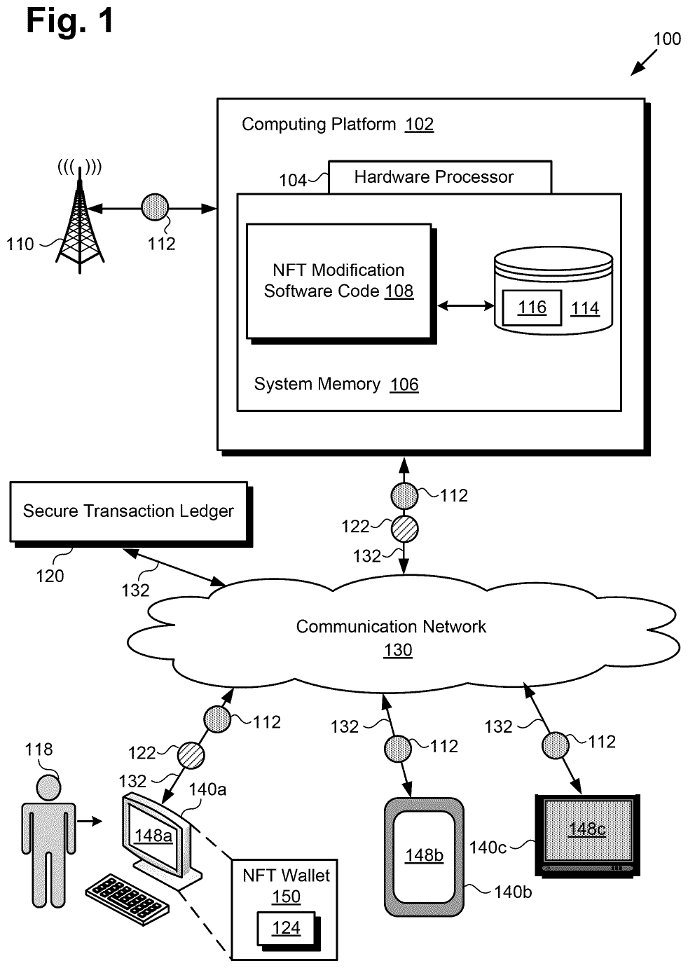

FIG. 1 shows exemplary system 100 for temporally adapting NFTs, according to one implementation. As shown in FIG. 1, system 100 includes computing platform 102 having hardware processor 104 and system memory 106 implemented as a computer-readable non-transitory storage medium. According to the present exemplary implementation, system memory 106 stores NFT modification software code 108 and user account database 114 having user account 116 of user 118 stored thereon. Regarding user account 116 of user 118, it is noted that user account 116 may include a record of account activity of user 118, such as the NFT ownership history of user 118, the content consumption history of user 118, purchases of merchandise or services by user 118, and the attendance history of user 118 at one or more venues.

As further shown in FIG. 1, system 100 is implemented within a use environment including content source 110 providing content 112. As depicted in FIG. 1, in some use cases, content source 110 may find it advantageous or desirable to make content 112 available via an alternative distribution mode, such as communication network 130, which may take the form of a packet-switched network, for example, such as the Internet. For instance, system 100 may be utilized by content source 110 to distribute content 112 as part of a content stream, which may be an Internet Protocol (IP) content stream provided by a streaming service, or a video-on-demand (VOD) service.

The use environment of system 100 also includes secure transaction ledger 120, and user systems 140a, 140b, and 140c (hereinafter “user systems 140a-140c”) receiving content 112 from system 100 via communication network 130. Also shown in FIG. 1 are NFT wallet 150 belonging to user 118 and storing NFT 124, request 122 received by system 100 from user 118, network communication links 132 of communication network 130 interactively connecting system 100 with secure transaction ledger 120 and user systems 140a-140c, as well as displays 148a. 148b, and 148c (hereinafter “displays 148a-148c”) of respective user systems 140a-140c.

It is noted that secure transaction ledger 120, described in greater detail below, may serve as the authoritative source of information regarding present and past ownership of NFT 124. In contrast to NFT wallet 150, which stores the NFT credentials certifying ownership of NFT 124 by user 118 and enables user to reassign, i.e., sell or otherwise transfer ownership of NFT asset to another person or entity, secure transaction ledger 120 provides a record of such transactions. Moreover, in contrast to user account 116 of user 118, which focuses on a variety of activities by user 118, including ownership of NFT 124, secure transaction ledger 120 includes information regarding user 118 only in so far as user 118 is a present or past owner of NFT 124.

With respect to user systems 140a-140c, it is further noted that although FIG. 1 depicts three user systems, that representation is merely by way of example. In other implementations, user systems 140a-140c may include as few as one user system, or more than three user systems. Moreover, although not shown in FIG. 1, each of user systems 140b and 140c may be utilized by a respective user corresponding to user 118 of user system 140a, each of whom may, like user 118, own a respective NFT wallet and a respective NFT other than NFT 124.

Although the present application refers to NFT modification software code 108 and user account database 114 as being stored in system memory 106 for conceptual clarity, more generally, system memory 106 may take the form of any computer-readable non-transitory storage medium. The expression “computer-readable non-transitory storage medium,” as used in the present application, refers to any medium, excluding a carrier wave or other transitory signal that provides instructions to hardware processor 104 of computing platform 102. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs such as DVDs, RAM, programmable read-only memory (PROM), erasable PROM (EPROM), and FLASH memory.

Moreover, although FIG. 1 depicts NFT modification software code 108 and user account database 114 as being co-located in system memory 106, that representation is also provided merely as an aid to conceptual clarity. More generally, system 100 may include one or more computing platforms 102, such as computer servers for example, which may be co-located, or may form an interactively linked but distributed system, such as a cloud-based system, for instance. As a result, hardware processor 104 and system memory 106 may correspond to distributed processor and memory resources within system 100. Consequently, in some implementations, NFT modification software code 108 and user account database 114 may be stored remotely from one another on the distributed memory resources of system 100.

In addition, although FIG. 1 shows user account database 114 as being stored in system memory 106 of system 100, that representation is also merely exemplary, in other implementations user account database 114 may not be a component of system 100, but rather may be a remote user account database accessible to system 100 via communication network 130 and network communication links 132. As noted above, user account 116 of user 118, it is noted that user account 116 may include a record of account activity of user 118, such as the NFT ownership history of user 118, the content consumption history of user 118, purchases of merchandise or services by user 118, and the attendance history of user 118 at one or more venues. That is to say, user account 116 may identify NFT 124 presently owned by user 118, NFTs previously owned by user 118, NFTs desired by user 118, what content 112 user 118 has viewed or is currently viewing, as well as the attendance and activity history of user 118 at various real-world venues, such as a theme park, resort property, hotel, or cruise ship, or at a virtual world venue, for example.

Hardware processor 104 may include multiple hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as NFT modification software code 108, from system memory 106, while a GPU may be implemented to reduce the processing overhead of the CPU by performing computationally intensive graphics or other processing tasks. A TPU is an application-specific integrated circuit (ASIC) configured specifically for artificial intelligence (AI) processes such as machine learning.

In some implementations, computing platform 102 may correspond to one or more web servers accessible over a packet-switched network such as the Internet, for example. Alternatively, computing platform 102 may correspond to one or more computer servers supporting a wide area network (WAN), a local area network (LAN), or included in another type of private or limited distribution network. In addition, or alternatively, in some implementations, system 100 may utilize a local area broadcast method, such as User Datagram Protocol (UDP) or Bluetooth, for instance. Furthermore, in some implementations, system 100 may be implemented virtually, such as in a data center. For example, in some implementations, system 100 may be implemented in software, or as virtual machines. Moreover, in some implementations, communication network 130 may be a high-speed network suitable for high performance computing (HPC), for example a 10 GigE network or an Infiniband network.

According to the exemplary implementation shown in FIG. 1, NFT wallet 150 can store one or more NFTs such as NFT 124 on user device 140a. However, in other implementations, NFT wallet 150 may not be resident on user device 140a, but may be a virtual wallet remote from user device 140, such as a cloud-based virtual wallet accessible to user device 140a via communication network 130 and network communication links 132. In yet other implementations, NFT wallet 150 may be a hardware cryptocurrency wallet, such as a Ledger Nano S® device or the like.

Secure transaction ledger 120 may take the form of a public or private secure transaction ledger. Examples of such secure transaction ledgers may include Blockchain, Hashgraph, Directed Acyclic Graph (DAG), and Holochain ledgers, to name a few. In use cases in which secure transaction ledger 120 is a blockchain ledger, it may be advantageous or desirable to implement secure transaction ledger 120 to utilize a consensus mechanism having a proof-of-stake (PoS) protocol, rather than the more energy intensive proof-of-work (PoW) protocol. Although secure transaction ledger 120 is shown to be remote from system 100 in FIG. 1, such as a cloud-based or distributed secure transaction ledger, that implementation is merely exemplary. In other implementations, secure transaction ledger 120 may be stored in system memory 106 and may be controlled by system 100.

It is noted that although user systems 140a-140c are shown variously as desktop computer 140a, smartphone 140b, and smart TV 140c, in FIG. 1, those representations are provided merely by way of example. In other implementations, user systems 140a-140c may take the form of any suitable mobile or stationary computing devices or systems that implement data processing capabilities sufficient to provide a user interface, support connections to communication network 130, and implement the functionality ascribed to user systems 140a-140c herein. That is to say, in other implementations, one or more of user systems 140a-140c may take the form of a laptop computer, tablet computer, digital media player, game console, or a wearable communication device such as a smartwatch, or AR or VR device to name a few examples. It is also noted that displays 148a-148c may take the form of liquid crystal displays (LCDs), light-emitting diode (LED) displays, organic light-emitting diode (OLED) displays, quantum dot (QD) displays, or any other suitable display screens that perform a physical transformation of signals to light.

In some implementations, content source 110 may be a media entity providing content 112. Content 112 may include content from a linear TV program stream, for example, that includes a high-definition (HD) or ultra-HD (UHD) baseband video signal with embedded audio, captions, time code, and other ancillary metadata, such as ratings and/or parental guidelines. In some implementations, content 112 may also include multiple audio tracks, and may utilize secondary audio programming (SAP) and/or Descriptive Video Service (DVS), for example. Alternatively, in some implementations, content 112 may be video game content. In various use cases, content 112 may be or include AV content, video unaccompanied by audio, audio unaccompanied by video, or text in the form of an electronic book or work of journalism. Specific examples of AV content include movies, TV episodes or series, video games, podcasts, and sporting events, which may be pre-recorded or received as a live feed for example.

In addition, or alternatively, in some implementations, content 112 may be or include digital representations of persons, fictional characters, locations, objects, and identifiers such as brands and logos, for example, which populate a VR, AR, or MR environment. Moreover, content 112 may depict virtual worlds that can be experienced by any number of users synchronously and persistently, while providing continuity of data such as personal identity, user history, entitlements, possessions, payments, and the like. It is noted that content 112 may also be or include a hybrid of traditional AV and fully immersive VR/AR/MR experiences, such as interactive video.

In some implementations, content 112 may be the same source video that is broadcast to a traditional TV audience. Thus, content source 110 may take the form of a conventional cable and/or satellite TV network, for example. As noted above, content source 110 may find it advantageous or desirable to make content 112 available via an alternative distribution mode, such as communication network 130, which may take the form of a packet-switched network, for example, such as the Internet, as also noted above. Alternatively, or in addition, although not depicted in FIG. 1, in some use cases content 112 may be distributed on a physical medium, such as a DVD, Blu-ray Disc®, or FLASH drive, for example.

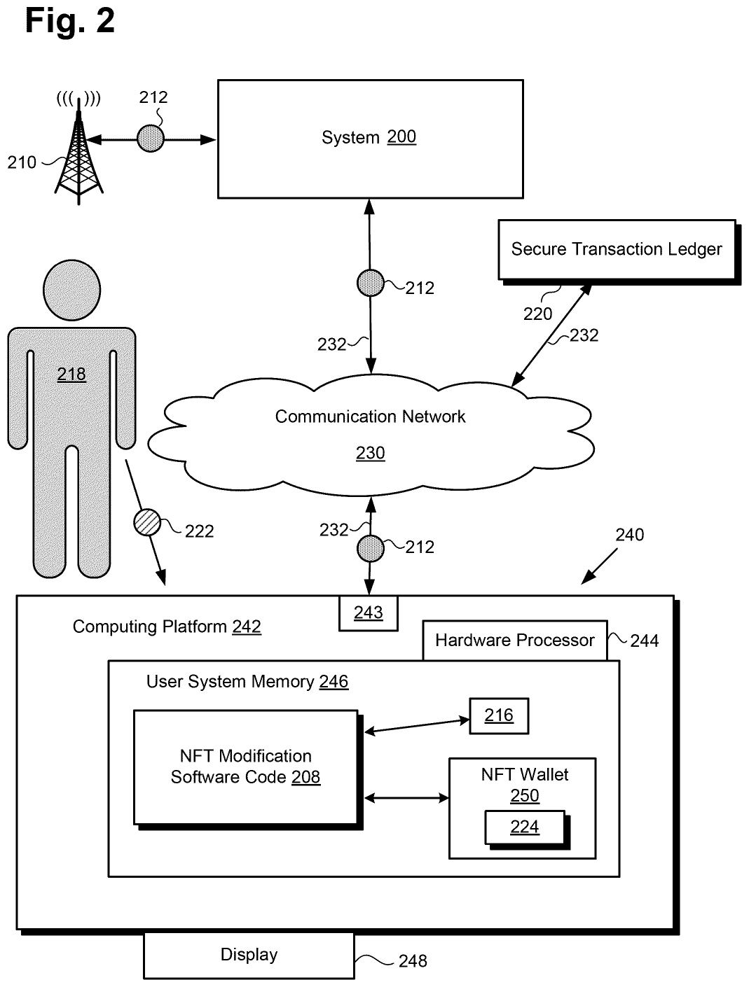

FIG. 2 shows another exemplary system, i.e., user system 240, for use in temporally adapting NFTs, according to one implementation. As shown in FIG. 2, user system 240 includes computing platform 242 having transceiver 243, hardware processor 244, user system memory 246 implemented as a computer-readable non-transitory storage medium, and display 248. As further shown in FIG. 2, user system memory 246 stores NFT modification software code 208, NFT wallet 250 containing NFT 224, and user account 216 of user 218 of user system 240. With respect to display 248, it is noted that, in various implementations, display 248 may be physically integrated with user system 240 or may be communicatively coupled to but physically separate from user system 240. For example, where user system 240 is implemented as a smart TV, smartphone, laptop computer, or tablet computer, display 248 will typically be integrated with user system 240. By contrast, where user system 240 is implemented as a desktop computer, display 248 may take the form of a monitor separate from computing platform 242 in the form of a computer tower.

As also shown in FIG. 2, user system 240 is utilized in use environment 200 including content source 210 providing content 212, secure transaction ledger 220, communication network 230, and network communication links 232. Also shown in FIG. 2 is request 222 provided as an input to user system 240 by user 218. According to the implementation shown in FIG. 2, NFT modification software code 208 stored in user system memory 246 of user system 240 is configured track content 212 consumed by user 218, as well as, in some implementations, one or more venues visited by user 218, or purchases or actions by user 218, by reference to user account 216, and to modify NFT 224 in response to any tracked features that are relevant to NFT 224. It is noted that content 212 consumed by user 218 can be tracked based on the user account credentials of user 218 on user system 240 or any other device on which user 218 consumes content 212. Purchases by user 218 actions can analogously be tracked based on user account 216 and any linked ecommerce sites.

Content source 210, content 212, secure transaction ledger 220, user 218, request 222, user account 216, NFT wallet 250, NFT 224, communication network 230, and network communication links 232 correspond respectively in general to content source 110, content 112, secure transaction ledger 120, user 118, request 122, user account 116, NFT wallet 150, NFT 124, communication network 130, and network communication links 132, in FIG. 1. In other words, content source 210, content 212, secure transaction ledger 220, user 218, request 222, user account 216, NFT wallet 250, NFT 224, communication network 230, and network communication links 232 may share any of the characteristics attributed to respective content source 110, content 112, secure transaction ledger 120, user 118, request 122, user account 116, NFT wallet 150. NFT 124, communication network 130, and network communication links 132 by the present disclosure, and vice versa.

Regarding user account 216 of user 218, it is noted that user account 216 may include a record of account activity of user 218, such as the NFT ownership history of user 218, the content consumption history of user 218, and the attendance history of user 218 at one or more venues. User account 216 may identify NFT 224 presently owned by user 218, NFTs previously owned by user 218, NFTs desired by user 218, what content 212 user 218 has viewed or is currently viewing, as well as the attendance and activity history of user 218 at various real-world venues, such as a theme park, resort property, hotel, or cruise ship, or at a virtual world venue, for example. Moreover, like NFT wallet 150 in FIG. 1, NFT wallet 250 can store one or more NFTs such as NFT 224 on user device 240. However, in other implementations, NFT wallet 250 may not be resident on user device 240, but may be a virtual wallet remote from user device 240, such as a cloud-based virtual wallet accessible to user device 240 via communication network 230 and network communication links 232. In yet other implementations, NFT wallet 250 may be a hardware cryptocurrency wallet, such as a Ledger Nano S® device or the like.

User system 240 and display 248 correspond respectively in general to any or all of user systems 140a-140c and respective displays 148a-148c in FIG. 1. Thus, user systems 140a-140c and displays 148a-148c may share any of the characteristics attributed to respective user system 240 and display 248 by the present disclosure, and vice versa. That is to say, like displays 148a-148c, display 248 may take the form of an LCD, LED display, OLED display, or QD display, for example. Moreover, although not shown in FIG. 1, each of user systems 140a-140c may include features corresponding respectively to computing platform 242, transceiver 243, hardware processor 244, and user system memory 246 storing NFT modification software code 208, NFT wallet containing NFT 224, and user account 216 of user 218.

Transceiver 243 may be implemented as a wireless communication unit configured for use with one or more of a variety of wireless communication protocols. For example, transceiver 243 may be implemented as a fourth generation (4G) wireless transceiver, or as a 5G wireless transceiver. In addition, or alternatively, transceiver 243 may be configured for communications using one or more of Wireless Fidelity (Wi-Fi), Worldwide Interoperability for Microwave Access (WiMAX), Bluetooth. Bluetooth low energy, ZigBee, radio-frequency identification (RFID), near-field communication (NFC), and 60 GHz wireless communications methods.

Hardware processor 244 of user system 240 may include multiple hardware processing units, such as one or more CPUs, one or more GPUs, one or more TPUs, and one or more FPGAs, for example, as those features are defined above.

NFT modification software code 208 corresponds in general to NFT modification software code 108, in FIG. 1. Thus, NFT modification software code 208 may share any of the characteristics attributed to NFT modification software code 108 by the present disclosure, and vice versa. Moreover, in implementations in which hardware processor 244 executes NFT modification software code 208 stored locally in user system memory 246, user system 240 may perform any of the actions attributed to system 100 by the present disclosure.

Referring to FIGS. 1 and 2 in combination, the present temporally adaptive NFT solution allows user 118/218 who owns NFT 124/224 to link NFT 124/224 to user account 116/216 of user 118/218. Over time, linked NFT 124/224 can gain attributes and properties that reflect key events or account activity of user account 116/216 related to content 112/212 consumed by user 118/218 that is relevant to NFT 124/224 or an activity or activities engaged in by user 118/218 that are relevant to NFT 124/224. For example, when NFT 124/224 is minted, the media content with which it will be associated may be known. That information can be included in metadata of a smart contract governing NFT 124/224. For example, where NFT 124/224 related to broadcast TV or streaming series “A” is minted, that NFT will be associated with each episode of that series, and can also be associated with elements such as individual character actions within episodes.

Thus, according to the present novel and inventive temporally adaptive NFT solution, NFTs are not static artifacts, but rather living artifacts that can be linked to a narrative timeline of content 112/212, and/or to events and activities recorded in user account 116/216. In effect, content source 110/210 can become a source of data for NFTs, with key events in narrative timelines resulting in modifications to the NFT. In some implementations, modification of NFT 124/224 could take effect at the time that content 112/212 is released for distribution. Alternatively, in some implementations, modification of NFT 124/224 could take effect in response to affirmative consumption of content 112/212 by user 118/218, or in response to activities engaged in by user 118/218.

By way of example, user John and user Jane each enjoy watching TV series A, and each owns an NFT associated with a different character in TV series A favored by John or Jane, respectively. John links his NFT to his user account 116/216, and Jane does the same for her NFT and her user account. As John and Jane watch TV series A, their respective NFTs change to reflect events in the show that are relevant to their respective favored characters. If, after consuming season 1 of TV series A, John and Jane watch season 2 or a movie or other content including their favored characters, their respective NFTs may continue to change to reflect events in season 2 or the other content. In this way, NFTs would gain changes in appearance (e.g., skins, special effects, animations) based on the temporal evolution of their associated characters, as well as changes to the metadata of a smart contract governing the NFT that relate to attributes about the character, such as relationship status, occupation, power, strength, health, etc. Notably, the NFTs of users who have watched season 2 would be further evolved and include different attributes than the NFTs of users who have only watched season 1.

Another implementation in which NFTs may be temporally adaptive to new content releases can lend itself to fantasy sports style drafting games. For example, prior to a new season release of a particular broadcast TV or streaming content series, users may be offered an opportunity to purchase NFTs of characters in the broadcast TV or streaming content series. Because the new season has not yet been released, those users do not know what will happen to which characters over the course of the new season. In other words, those users cannot know what effects and consequences the new season will have for the characters associated with the NFTs they purchase, and further purchases may not be allowed once the new season begins to air.

According to this exemplary implementation, purchase of an NFT for a character that leaves the series early on in a season (e.g., the character is written off, eliminated, dies, etc.) might result in an NFT having less value than an NFT of a character who makes it to the end of the season. Alternatively, in some of these implementations, if a character leaves during the series, then the NFTs linked to that character could be burned or otherwise revoked and only NFTs linked to surviving characters may remain at the end of each season. In this way, the reward of owning any given NFT would depend on the performance and progress of the character associated with that NFT in the series.

Alternatively, or in addition, in various implementations the modification to NFT 124/224 owned by user 118/218 may be based on one or more of purchases by user 118/218, events such as movie premieres and sporting events attended by user 118/218, theme park rides or experiences enjoyed by user 118/218, or locations visited by user 118/218, to name a few examples. Purchases of qualifying physical goods by user 118/218 could be verified utilizing user device 140a/240 to scan a Quick Response (QR) code or other identifier printed on the physical good. Attendance at an event or theme park could be verified based on purchase of an admission ticket by user 118/218, either a physical purchase at the event or theme park, or a digital purchase, such as an online purchase for example.

In use cases in which the modification to NFT 124/224 owned by user 118/218 is based on a location visited by user 118/218, that location may be a real-world location such as a city, a recreation or resort property, an entertainment venue, a hotel, a cruise ship, or the immediate vicinity. e.g., within ten feet or any other predetermined distance, of a physical object or coordinate (e.g., latitude and longitude). The presence of user 118/218 at a particular location may be confirmed to an arbitrary level of precision using one or more of GPS data, RFID recognition, NFC recognition, or Bluetooth LE communications, to name a few examples.

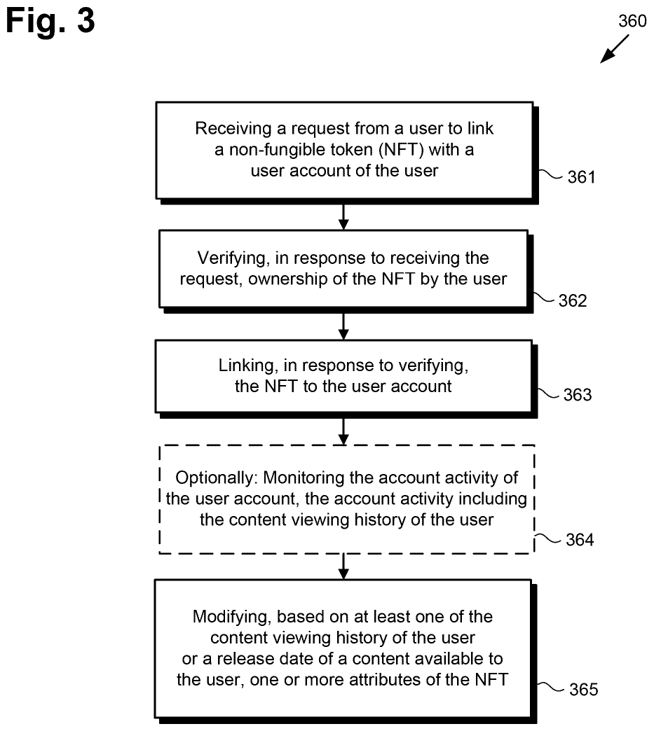

The functionality of NFT modification software code 108/208 will be further described below with reference to FIG. 3. FIG. 3 shows flowchart 360 presenting an exemplary method for temporally adapting NFTs, according to one implementation. With respect to the method outlined by FIG. 3, it is noted that certain details and features have been left out of flowchart 360 in order not to obscure the discussion of the inventive features in the present application.

Referring to FIG. 3 with further reference to FIGS. 1 and 2, flowchart 360 includes receiving request 122/22 from user 118/218 to link NFT 124/224 with user account 116/216 of user 118/218 (action 361). In some implementations, as shown in FIG. 1, request 122 may be transmitted from user device 140a to system 100 via communication network 130 and network communication links 132. User account 116 to which user 118 requests that NFT 124 be linked may be stored on user account database 114. In those implementations, request 122 may be received in action 361 by NFT modification software code 108, executed by hardware processor 104 of system 100.

Referring to FIG. 2, in other implementations, request 222 may be provided as an input to user system 240 by user 218, through use of an input device such as a keyboard or touchscreen for example, or via a voice command, and may request that NFT 224 stored in NFT wallet 250 be linked to user account 216 of user 218. In those other implementations, request 222 may be received in action 361 by NFT modification software code 208, executed by hardware processor 244 of user system 240.

Continuing to refer to FIGS. 1, 2, and 3 in combination, flowchart 360 further includes verifying, in response to receiving request 122/222, ownership of NFT 124/224 by user 118/218 (action 362). According to the exemplary implementation shown in FIG. 1, hardware processor 104 of system 100 may execute NFT modification software code 108 to verify ownership of NFT 124 by user 118 through reference to secure transaction ledger 120 in action 362. Alternatively, according to the exemplary implementation shown in FIG. 2, hardware processor 244 of user system 240 may execute NFT modification software code 208 to verify ownership of NFT 224 by user 218 through reference to NFT wallet 250 or secure transaction ledger 220.

Continuing to refer to FIGS. 1, 2, and 3 in combination, flowchart 360 further includes linking, in response to the verification performed in action 362, NFT 124/224 to user account 116/216 (action 363). In some implementations, as shown in FIG. 1, NFT 124 identified in request 122 may be linked to user account 116 of user 118, stored on user account database 114. In those implementations, action 363 may be performed by NFT modification software code 108, executed by hardware processor 104 of system 100. As shown in FIG. 2, in other implementations, NFT 224 identified in request 222 may be linked to user account 216 of user 218, stored on user system 240. In those implementations, action 363 may be performed by NFT modification software code 208, executed by hardware processor 244 of user system 240.

Continuing to refer to FIGS. 1, 2, and 3 in combination, in some implementations, flowchart 360 may optionally further include monitoring the account activity of user account 116/216, the account activity including a content viewing history of user 118/218 (action 364). In some implementations, action 364 may be performed by NFT modification software code 108, executed by hardware processor 104 of system 100, by reference to user account 116 of user 118, stored on user account database 114. In other implementations, action 364 may be performed by NFT modification software code 208, executed by hardware processor 244 of user system 240, by reference to user account 216 of user 218.

As noted above, user account 116/216 of user 118/218 may include a record of account activity of user 118/218, such as the NFT ownership history of user 118/218, the content consumption history of user 118/218, and the attendance history of user 118/218 at one or more venues. That is to say, user account 116/216 may identify NFT 124/224 presently owned by user 118/218, NFTs previously owned by user 118/218, NFTs desired by user 118/218, what of content 112/212 user 118/218 views and has viewed, as well as the attendance and activity history of user 118/218 at various real-world venues, such as a theme park, resort property, hotel, or cruise ship, or at a virtual world venue, for example.

Continuing to refer to FIGS. 1, 2, and 3 in combination, flowchart 360 further includes modifying, based on one or both of the content viewing history of user 118/218 or the release date of content 112/212 available to user 118/218, one or more attributes of NFT 124/224 (action 365). It is noted that, in some implementations user 118/218 must merely reach certain timestamps for the modification of NFT 124/224 to take place. The amount of time required can be dependent on content 112/212 itself. For example, assume that NFT 124/224 is minted so as to be associated with certain character in broadcast TV or streaming series: if that character only appears within the first few minutes of an episode, user 118/218 may only have to watch until the time that appearance of the character concludes, i.e., those first few minutes of the episode. However, if the character continues to appear at least periodically until the end of the episode, then user 118/218 may have to watch until that end point. It is further noted that “spoilers” may be eliminated by requiring that user 118/218 actually consume content 112/212, by reference for example to user account 116/216, in order to modify NFT 124/224. Another option is to automatically modify NFT 124/224 when content 112/212 is released.

In some implementations, modifying the one or more attributes of NFT 124/224, in action 365, may be performed by NFT modification software code 108, executed by hardware processor 104 of system 100. In other implementations, modifying the one or more attributes of NFT 124/224, in action 365, may be performed by NFT modification software code 208, executed by hardware processor 244 of user system 240.

Modifying the one or more attributes of NFT 124/224 may include updating a smart contract governing NFT 124/224 and/or adding metadata to NFT 124/224 identifying the modification. In some implementations, the modification to the one or more attributes of NFT 124/224 causes the appearance of NFT 124/224 to change. For example, where NFT 124/224 corresponds to an image of a movie character, the modification of the one or more attributes of NFT 124/224 performed in action 365 may result in portrayal of the same movie character having one or more of a different costume, different coloring, possessing different accessories, framed against a different background environment, wearing a different expression, or stamped with a limited release number, date, time, or geolocation identifier, to name a few examples. In some use cases in which user 118/218 is unhappy with the modification of NFT 124/224 performed in action 365, that modification may be reversible at the request of user 118/218. However, in other use cases, modification of NFT 124/224 may be an irreversible process in which the previous, unmodified, version of NFT 124/224 is lost to user 118/218 forever.

In addition, or alternatively, in some implementations, the modification to the one or more attributes of NFT 124/224 may cause the value associated with the NFT to change. For example, where NFT 124/224 corresponds to a TV character whose role increases in importance relative to the plotline of a TV series over the course of a season, the value of NFT 124/224 may increase as user 118/218 consumes content 112/212 including episodes of that season. For example, the value of NFT 124/224 may increase due to increasing scarcity as NFT 124/224 is modified, because those modifications to NFT 124/224 may make NFT 124/224 more unique. Conversely, where NFT 124/224 corresponds to a TV character whose role decreases in importance relative to the plotline of a TV series over the course of a season, the value of NFT 124/224 may decrease as user 118/218 consumes content 112/212 including episodes of that season. Moreover, in some implementations in which a character leaves a TV series, such as through disqualification or death, modifying the one or more attributes of NFT 124/224 corresponding to that character may include revoking NFT 124/224.

As noted above, the account activity in user account 116/216 may include the attendance history of user 118/218 at a venue. In some implementations, modifying the one or more attributes of NFT 124/224 in action 365 may be further based on that attendance history. Such a venue may be a physical real-world location or a virtual world location where NFTs can be traded, exchanged, granted, or revoked. It is noted that, in various implementations in which the venue is a real-world location, that venue may be the entire limits of a city, a recreation or resort property, a theme park or other entertainment venue, a cruise ship, or the immediate vicinity, e.g., within ten feet or any other predetermined distance, of a physical object or coordinate (e.g., latitude and longitude). In some implementations in which modifying the one or more attributes of NFT 124/224 in action 365 is further based on an attendance history of user 118/218 at a venue, modifying the one or more attributes of NFT 124/224 may entitle user 118/218 to a VR. AR, or MR experience.

In implementations in which the venue is a virtual world location, the venue may be or include digital representations of persons, fictional characters, locations, objects, and identifiers such as brands and logos, for example, which populate a VR, AR, or MR environment. Moreover, such a virtual world location may be one that can be experienced by any number of users synchronously and persistently, while providing continuity of data such as personal identity, user history, entitlements, possessions, payments, and the like. Furthermore, such a virtual world location may include a hybrid of traditional audio-video based and fully immersive VR/AR/MR experiences, such as interactive video. Thus, in some implementations, the venue attended by user 118/218 may be or include an interactive video environment providing at least one of a VR, AR, MR experience to user 118/218.

It is noted that hardware processor 104 of system 100, or hardware processor 244 of user system 240, may further execute respective NFT modification software code 108 or 208 to report the details of the modification to NFT 124/224 on secure transaction ledger 120/220, which may serve as the sole repository of that action. It is further noted that the actions described by flowchart 360 may advantageously be performed by system 100 as an automated process. That is to say actions 361, 362, 363, and 365, or actions 361, 362, 363, 364, and 365, may be performed in an automated process from which human involvement may be omitted.

Thus, the present application discloses systems and methods for temporally adapting NFTs. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor and a system memory storing a software code;
the hardware processor configured to execute the software code to:
receive a request from a user to link a non-fungible token (NFT) with a user account of the user;
verify, in response to receiving the request, ownership of the NFT by the user;
link, in response to verifying, the NFT to the user account; and
modify, based on at least one of a content viewing history of the user or a release date of a content available to the user, one or more attributes of the NFT.

2. The system of claim 1, wherein modifying the one or more attributes of the NFT comprises updating a smart contract governing the NFT.

3. The system of claim 1, wherein modifying the one or more attributes of the NFT is based at least in part on the content viewing history of the user, and wherein prior to modifying the one or more attributes of the NFT the hardware processor is further configured to execute the software code to:
monitor an account activity of the user account, the account activity including the content viewing history of the user.

4. The system of claim 3, wherein the account activity further includes an attendance history of the user at a venue, and wherein modifying the one or more attributes of the NFT is further based on the attendance history.

5. The system of claim 4, wherein the venue is a real-world location.

6. The system of claim 4, wherein the venue is a physical location within one of a theme park, resort property, hotel, or cruise ship.

7. The system of claim 4, wherein the venue is an interactive video environment providing at least one of a virtual reality, an augmented reality, or a mixed reality experience to the user.

8. The system of claim 1, wherein modifying the one or more attributes of the NFT causes at least one of: an appearance of the NFT to change or a value associated with the NFT to change.

9. The system of claim 1, wherein modifying the one or more attributes of the NFT comprises revoking the NFT.

10. The system of claim 1, wherein modifying the one or more attributes of the NFT entitles the user to a virtual reality, an augmented reality, or a mixed reality experience.

11. A method for use by a system including a hardware processor and a system memory storing a software code, the method comprising:
receiving, by the software code executed by the hardware processor, a request from a user to link a non-fungible token (NFT) with a user account of the user;
verifying, by the software code executed by the hardware processor in response to receiving the request, ownership of the NFT by the user;
linking, by the software code executed by the hardware processor in response to verifying, the NFT to the user account; and
modifying, by the software code executed by the hardware processor based on at least one of a content viewing history of the user or a release date of a content available to the user, one or more attributes of the NFT.

12. The method of claim 11, wherein modifying the one or more attributes of the NFT comprises updating a smart contract governing the NFT.

13. The method of claim 11, wherein modifying the one or more attributes of the NFT is based at least in part on the content viewing history of the user, the method further comprising:
monitoring, by the software code executed by the hardware processor prior to modifying the one or more attributes of the NFT, an account activity of the user account, the account activity including the content viewing history of the user.

14. The method of claim 11, wherein the account activity further includes an attendance history of the user at a venue, and wherein modifying the one or more attributes of the NFT is further based on the attendance history.

15. The method of claim 14, wherein the venue is a real-world location.

16. The method of claim 14, wherein the venue is a physical location within one of a theme park, resort property, hotel, or cruise ship.

17. The method of claim 14, wherein the venue is an interactive video environment providing at least one of a virtual reality, augmented reality, or mixed reality experience to the user.

18. The method of claim 11, wherein modifying the one or more attributes of the NFT causes at least one of: an appearance of the NFT to change or a value associated with the NFT to change.

19. The method of claim 11, wherein modifying the one or more attributes of the NFT comprises revoking the NFT.

20. The method of claim 11, wherein modifying the one or more attributes of the NFT entitles the user to a virtual reality, an augmented reality, or a mixed reality experience.
